(19) United States
(12) Patent Application Publication
(10) Pub. No.: US 2011/0199204 A1
(43) Pub. Date: Aug. 18, 2011

(54) COMMUNICATING DEVICE AND METHOD OF LOCKING OUT AN ITEM OF EQUIPMENT

(75) Inventors: François Dionis, Rueil Malmaison (FR); Eric Perrier De La Bathie, Montesson (FR); Vincent Joly, Dampierre En Burly (FR)

(73) Assignee: ELECTRICITE DE FRANCE, Paris (FR)

(21) Appl. No.: 13/005,658

(22) Filed: Jan. 13, 2011

(30) Foreign Application Priority Data
Jan. 14, 2010 (FR) 10 50217

(51) Int. Cl. G08B 29/00; G08B 21/00

(52) U.S. Cl. 340/506; 340/636.1

(57) ABSTRACT

A communicating lockout device of an item of equipment comprising locking means able to maintain the equipment in a fixed position, a communication module able to communicate data relating to said device and a local power supply module adapted to supply electrically at least the communication module, the power supply module comprising a charge monitoring unit arranged for measuring the charge level of the local power supply module. The invention also relates to a network for the supervision of a plurality of items of equipment using such a communicating device as well as to a corresponding supervision method.

### CROSS-REFERENCE TO RELATED PATENT APPLICATION

This application claims the benefit of French Patent Application No. 10 50217, filed on Jan. 14, 2010, in the French Institute of Industrial Property, the entire contents of which is incorporated herein by reference.

### FIELD OF THE INVENTION

The invention relates to the field of the supervision of items of equipment in industrial installations, and more particularly the use of communicating devices making it possible to lock out certain items of equipment in such industrial is installations.

### BACKGROUND

In large scale industrial installations, and in particular in the nuclear industry, padlocks and chains are currently used for mechanically locking an item of equipment, in general a valve, in a position required by the operation. Such mechanical locking in a fixed position is required either for personnel safety constraints, or for nuclear safety constraints. This type of mechanical locking is commonly called “lockout” or “immobilization”.

The standard UTE C 18-510, in chapter 2.4.14 “lockout of an apparatus” indicates that the lockout of an apparatus consists in carrying out the operations necessary for putting it and keeping it in a specified position (whether that is open or closed), prohibiting its operation and indicating that the locked out apparatus must not be operated.

In practice, locked out items of equipment on site are indicated by a sign fixed either on the chain or on the shank of the padlock.

There is currently a need to go further with regard to making the management of lockouts reliable. In fact, the installation of lockouts can be subject to human error and, moreover, the supervision of these lockouts is difficult to carry out when the latter involve a multitude of items of equipment situated in places which are difficult to access, as is the case with valves in an industrial installation.

Communication systems already exist for monitoring transportable objects, such as for example those described in the U.S. Patent Application Publication No. 2002/0133704 A1 or in the Dutch patent NL 1018534. However, these communicating systems are specifically adapted to transportable items of equipment and do not guarantee the mechanical locking of an item of equipment such as a valve. Moreover, the autonomy of the electrical power supply of the devices described in these communicating systems is not monitored, which makes them unsuitable for an industrial environment in which it is appropriate to limit as much as possible interventions on lockouts which can be installed over a long period.

### SUMMARY

One of the purposes of the present invention is therefore to guarantee the putting of an item of equipment in the required position, as well as the supervision of keeping the item of equipment in that position over a period compatible with long industrial cycles.

Another purpose of the present invention to allow optimized management of the autonomy of electrical power supply of devices used in the lockout of items of equipment, whilst controlling costs and delays particularly in the case of a large number of devices to managed.

For these purposes, the present invention proposes a device for the lockout of an item of equipment comprising locking means able to maintain the equipment in a fixed position, a communication module able to communicate at least the data relating to said locking means and a local power supply module adapted to supply electrically at least the communication module. The local power supply module comprises a charge monitoring unit arranged for measuring the charge level of the local power supply module. It is thus possible for an operator to supervise the remaining autonomy of the communicating device because of the measurement carried out by the charge monitoring unit.

The communication module advantageously comprises a transmission unit connected to the charge monitoring unit and arranged for transmitting, to a remote supervision system, a charge data item determined according to the measured charge level, which allows remote supervision of the electrical autonomy of the communicating device.

In particular, the item of charge data can advantageously be proportional to the measured charge level, in order to allow a fine remote supervision of the electrical autonomy of the communicating device.

In an advantageous embodiment, this item of charge data is measured at a predetermined measuring frequency and the transmission unit is activated periodically, at a first predetermined transmission frequency lower than this measuring frequency, in order to transmit that item of charge data to the remote supervision system. The autonomy of the communicating device can thus be optimized by activating the transmission unit at a reduced rate.

In another advantageous embodiment, the communication module comprises at least a first display unit connected to the charge monitoring module, which is arranged to produce at least a predetermined display depending on the measured charge level, which allows local management of the autonomy of the communicating device by an operator.

Preferably, the communicating device comprises a test module connected to the locking means and arranged for measuring the variation of at least one parameter of said locking means at a predetermined test frequency and the transmission unit is activated periodically, at a second predetermined transmission frequency, lower than the test frequency, in order to transmit to the remote supervision system an item of lockout data determined according to the measured variation, in order to optimize the autonomy of the communicating device by activating the transmission unit at a reduced rate.

Preferably, the communicating device comprises an electrically passive identification means, which allows the identification of the device and its association with a particular item of equipment whilst safeguarding its electrical autonomy.

The present invention relates moreover to a network for the supervision of a plurality of items of equipment comprising a plurality of communicating lockout devices such as described above and a supervision server capable of receiving data from each one of said communicating lockout devices, each item of equipment of said plurality of items of equipment being locked in a fixed position by at least one of said communicating lockout devices.

The present invention also relates to a method of supervision of the locking of an item of equipment by a communicating lockout device powered by a local power supply module, the method comprising the association of said communicating lockout device with the item of equipment placed in a fixed position, followed by the supervision of the communicating lockout device, the supervision step comprising the measurement of the charge level of the local power supply.

Advantageously, the supervision step comprises the transmission to a supervision system of at least one item of charge data determined according to the measured charge level and/or the activation of a display unit of the device according to the measured charge level, which makes it possible to manage the autonomy of the communicating device both remotely and locally.

In an advantageous embodiment, the measurement of the charge level is carried out periodically at a predetermined measuring frequency and the transmission step comprises the periodic activation of a transmission unit, at a first predetermined transmission frequency lower than the measuring frequency, in order to transmit the item of charge data to the remote supervision system, in order to optimize the autonomy of the communicating device by activating the transmission unit at a reduced rate.

Preferably, when the communicating lockout device comprises locking means capable of locking the item of equipment in a fixed position, the supervision step comprises a test sub-step during which the variation of at least one parameter of said locking means is measured periodically at a predetermined test frequency, the transmission step then comprising the periodic activation of a transmission unit, at a second predetermined transmission frequency lower than the test frequency, in order to transmit to the remote supervision system an item of lockout data determined according to the measured variation, in order to optimize the autonomy of the communicating device by activating the transmission unit at a reduced rate.

Preferably, an alarm signal is transmitted if no data is received from the communicating device by the supervision system over a period longer than a predetermined number of transmission cycles or depending on the item of charge and/or lockout data received. The supervisor is thus informed that a corrective action on the device is necessary.

Preferably, when the communicating lockout device comprises a first electrically passive identification means and the equipment has a second electrically passive identification means, the association step comprises a sub-step of virtual association of the device and the item of equipment during which said identification means are read by a portable device and associated in a memory of said portable device. The item of equipment and its device are thus associated whilst safeguarding the electrical autonomy of the device.

In an advantageous embodiment, the method comprises a step of prior preparation of the device comprising the verification of the last item of charge data transmitted to the supervision system by the communicating device, which makes it possible to verify that the device has sufficient autonomy before associating it with the equipment.

In another advantageous embodiment, the method comprises a step of activation of the communicating device following its association with the item of equipment as well as the verification of the communication between the communicating device and the remote supervision system, in order to avoid consuming the electrical energy stored in the local power supply before being assured that communication with the supervision system is correctly established.

### BRIEF DESCRIPTION OF THE DRAWINGS

The communicating lockout device which is the subject of the invention will be better understood on reading the description and on observing the drawings hereafter in which:

FIG. 1 shows a communicating lockout device according to the present invention;

FIG. 2A shows the steps of a method of supervision of an item of equipment locked by means of the communicating lockout device according to the present invention;

FIG. 2B shows in detail the sub-steps constituting the supervision step of the above method according to the present invention; and

FIG. 3 shows a system for the supervision of a plurality of items of equipment comprising a plurality of communicating lockout devices and a supervision server to communicate with each of said communicating lockout devices according to the present invention.

### DESCRIPTION OF PREFERRED EMBODIMENTS

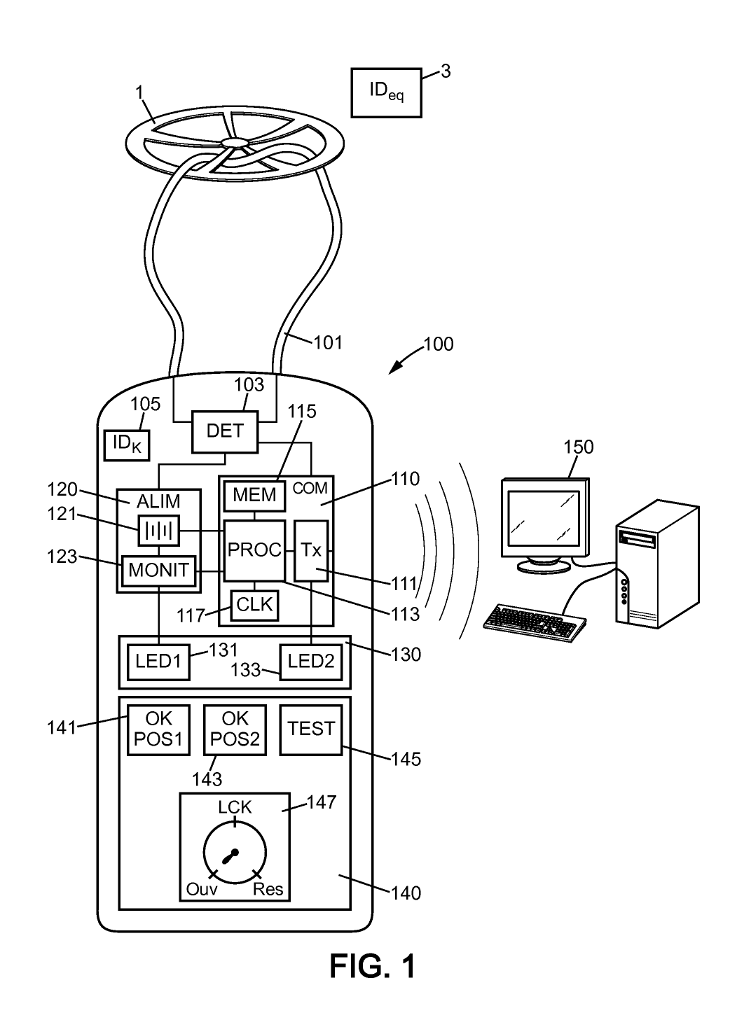

Reference will firstly be made to FIG. 1 in which is shown a communicating lockout device 100 intended to lock out an item of equipment 1 in a fixed position. Such an item of equipment can for example be a valve in an industrial installation, which can be locked out in the open or closed position depending on the context.

For this purpose, the device 100 comprises locking means 101 capable of keeping the item of equipment 1 in a specified fixed position. Such locking means 101 can consist of a cable capable of mechanically tightly holding the item of equipment (the control wheel of a valve by way of purely illustrative example) in order to keep it in a given position.

The device 100 also comprises a communication module 110 capable of communicating data to a supervisor, in particular data relating to the locking means 101 in order to inform the supervisor about the status these means.

Such a communication module 110 thus comprises a transmission unit 111 in order to allow the connection of the device 100 to a remote supervision system 150. This transmission unit 111 is preferably wireless and comprises a radio antenna able to transmit and receive signals transmitted by radio, in order to have total freedom with regard to the location where the device 100 is placed, and communicates with the remote supervision system 150 by means of a wireless network, for example of the Zigbee, ZigbeePro, Occari, WirelessArt or WiFi type. Such a radio antenna is preferably integrated inside the casing of the communicating device 100, in order to prevent it from being damaged during its transport. A connector allows the use of an antenna outside of the casing.

The communication module 110 also comprises a processor 113 capable of managing the transmission unit 111 and connected to memory means 115 and a clock 117. All of the components of the communication module 110 can be integrated in an electronic card.

The memory means 115, for example a register, make it possible to store certain data necessary for the correct functioning of the device 100. Thus, with regard to the autonomy of the local power supply module 120, the type of the power supply means 121 used, and consequently their respective capacities, will change over the course of time. It is therefore possible to calibrate the device 100 according to the type of new power supply means 121 inserted. The memory means 115 make it possible to store, for this purpose, certain characteristics of these power supply means 121 such as their capacity or their characteristic discharge curve. On each change of power supply means 121, the values stored in the memory means 115 can be reinitialized according to the characteristics of the new means 121.

The device 100 comprises moreover a local power supply module 120 making it possible to power the components of the device 100 requiring electrical energy, including among others the communication module 110, in a completely autonomous manner.

Such a power supply module comprises energy storage means 121 such as battery cells (for example in the standard AAA format), or a battery, which can be changed without removing the casing of the device 100. The lifetime of the cell or of the battery used can have a minimum duration in order to guarantee the correct functioning of the device 100 over a period compatible with the type of industrial installation in question (for example 24 months in the case of a nuclear fuel cycle).

Such energy storage means 121 can be placed in a compartment of the casing accessible by opening a dedicated cover. It is also possible to cast a cell, and the electronics of the communication module 110, in resin in order to comply with the ATEX standard.

The local power supply module 120 comprises moreover a charge monitoring unit 123 capable of measuring the charge level of the energy storage means 121, and therefore the autonomy of the local power supply module 120. This measurement of the charge level can be carried out, for example, by measuring the voltage across the terminals of the storage means 121 and makes it possible to determine a data item called a “charge data item” according to the measured charge level of the local power supply module. Such a charge data item can advantageously be proportional to the measurement made or can simply indicate that this charge level is correct if the measured value exceeds a certain predetermined threshold.

Thus, due to the determination of such a charge data item, it is possible to have an estimation of the remaining autonomy of the communicating device 100 in order to determine if the latter is sufficient for locking out the corresponding item of equipment 1 for a period compatible with the lockout desired by the supervisor.

The charge monitoring unit 123 is moreover advantageously connected to the transmission unit 111 of the communication module 110, this unit 111 then being arranged to transmit at least one item of charge data relating to the charge level of the local power supply module 105 to the remote supervision system 150, this item of charge data advantageously being able to be proportional to the measurement of the charge level in order to allow a fine supervision of the autonomy of the communicating device.

It is thus possible to supervise the remaining autonomy of the different communicating devices already in place practically in real time and in a centralized manner, via the remote supervision system 150. The supervisor in charge of this task can then decide on the replacement or on the recharging of the device 100 according to its remaining charge level.

In the advantageous mode where the transmitted item of charge data is proportional to the charge level measurement, the supervisor has a precise knowledge of the remaining autonomy of all of the communicating devices and can therefore plan more efficiently and anticipate the replacement of certain communicating devices, or their electrical recharging, according to logistic, difficulty of access and cost criteria.

This technical advantage is particularly important when a large quantity of communicating devices are to be monitored simultaneously, which causes logistic problems making it necessary to anticipate as much as possible the replacement and/or recharging operations of these communicating devices.

Insofar as the communication module 110, and in particular its transmission unit 111, are the components that are the heaviest consumers of this device 100, it is advantageous to activate the communication module 110 only when this is necessary in order to optimize the autonomy of the device 100. The clock 117 allows the periodic activation and the deactivation of the components of the communication module 110 at certain frequencies corresponding to very precise actions.

Thus, provision is made, on the one hand, to periodically carry out the transmission of data to the supervision system 150 in the form of data frames. The clock 117 will therefore activate the transmission unit 111 at certain frequencies, in order that the latter transmits a data frame before being deactivated. The frequency f_{Tx} of activation of the transmission unit 111, for transmitting these items of information to the supervision system, can be set (between 1 and 40 minutes), or even fixed at a certain value (for example 4 minutes). However, the transmission of data frames can also be carried out at a lower frequency, still in order to optimize the autonomy of the power supply of the device 100.

The measurement of the charge level of the device 100, and the determination of the item of charge data resulting from this, can also be carried out periodically, for example at a certain measuring frequency f_{M}, which is not necessarily equal to the transmission frequency f_{Tx,M} of a measurement frame comprising this data item to the supervision system, this latter frequency f_{Tx,M} being able to be set up. It is thus particularly advantageous to use a transmission frequency f_{Tx,M} lower than the measurement frequency f_{M}, for energy saving reasons. For example, it is possible to transmit the charge data only every five or twenty measurements.

Moreover, the communication module comprises display means 130 making it possible to inform the operator operating the device 100 about certain of its parameters.

The display means 130 include a first display unit 131 connected to the charge monitoring unit 123 and allowing a predetermined display according to the data item relating to the charge level of the local power supply module determined by the charge monitoring unit, which gives an indication of the charge level of the device 100 to an operator operating it. Thus, when the charge level detected by the charge monitoring module reaches a certain predetermined low threshold, the supervision application triggers a charge level alarm. The display unit 131 indicates such an alarm, for example by flashing in red, in order to warn any nearby operator.

The display means 130 can also comprise a second display unit 133 associated with the transmission unit 111 in order to give an indication on the status of the communication with the supervision system. Such display units can consist, for example, of one or more light emitting diodes and they make it possible to warn the operator operating the device 100 of the charge state of the power supply module and of the communication status of the communication module respectively.

Thus, when the operator prepares the device 100 in order to place it on the equipment 1 to be locked out, he can be informed regarding the charge level of the device and decide to use it (or not) according to this information, as will be illustrated below.

The communication module can also comprise an identification means 105 chosen to be electrically passive in order to increase the energy autonomy of the device 100. By “electrically passive” is meant here that the identification means 105 does not consume electrical energy and does not therefore discharge the local power supply module 120, to which it is not electrically connected. The identification means 105 can consist of an RFID tag or a 2D bar code, for example.

Such means of identification 105 make it possible to associate a particular communicating device 100 with a particular item of equipment 1. If the item of equipment 1 also has an identification means 3, such as for example an RFID tag or a 2D bar code, then computer logging is possible by means of a personal digital assistant (PDA), during which logging the identity of the communicating lockout device and the equipment with which the latter is associated will be stored together.

The fact of using an electrically passive identification means 105 is particularly advantageous in the present case, insofar as the autonomy of the device 100 is thereby increased, which is particularly useful when the lockout of the equipment 1 is predicted to last for a certain time.

The device 100 comprises moreover a test module 103 connected to the locking means 101. This module 103 is capable of measuring the variation of at least one parameter relating to these locking means, by measuring this parameter and comparing it with a reference value for example, in order to obtain the determination of a so-called “lockout” data item giving an indication of the locked (or not locked) state of the locking means 101 or of the compromising of their integrity. The change of state of the locking means can thus be detected by means of this detection module 103 and the lockout data item indicating this change of state can be communicated to a supervisor by means of the communication module 110.

The detection module 103 can for example detect the disappearance of an electrical current flowing in the locking means when an electrical current flows through them continuously. The parameter to be monitored can thus be the value of the electric current and a variation of the current value exceeding a certain predetermined threshold can be indicative of the unlocking of the means 101.

The lockout data item can be directly proportional to the variation of the parameter in question, in which case the verification of the state of the means 101 will be carried out remotely, or can be determined according to a comparison of this variation with a predetermined threshold in the communicating device, in which case the lockout data will be simply indicative of the correct locking (or not) of the locking means 101.

This detection test can be continuous, but it will preferably be carried out periodically at a certain predetermined test frequency f_{Test}, in order to optimize the autonomy of the device 100. Such a test frequency f_{Test} can be set up (for example between 1 and 5 minutes) or fixed at a certain default value (1 minute for example). The frequency of transmission f_{Tx,Test} of a data frame comprising a lockout data item indicative of the change of state of the means 101 is advantageously lower than the test frequency test f_{Test}, in order to limit the power consumption of the transmission unit 111.

The device 100 can moreover comprise activation means 140 making it possible for an operator to activate certain functions of the device 100. In the present example, the activation means 140 include three push buttons 141,143 and 145 in order to respectively communicate the fact that the equipment 1 is positioned in a first position (for example open), to communicate the fact that the equipment 1 is positioned in a second position (for example closed) and to initiate a procedure for testing the state of the locking means 101. These push buttons 141,143 and 145 can be protected physically, for example by being covered by “Lexan” buttons, and controlled by software.

The activation means 140 include moreover a lock 147 capable of activating a change of operating mode of the device 100 by the insertion of a key specific to the operator. In the example of FIG. 1, this lock can assume three positions “Open”, “LCK” and “NTWK” in order to put the device 100 into the “Open”, “Locked” and “Network” mode respectively as will be illustrated below.

Thus, the communication module 110 can be activated in four different ways:
when new power supply means 121 are inserted;
on putting into service by the operator using the key and the lock 147;
when the operator presses the test button 145; and
internally, due to the clock 117, for the measuring, testing and radio transmission cycles.

These limited activation phases make it possible to limit the electrical consumption of the communication module 110 to the minimum necessary, thus safeguarding its electrical autonomy.

The communicating lockout device 100 is moreover preferably designed to withstand severe environmental stresses: high temperature, spraying with acidic or alkaline products, impacts, ionizing radiations. With regard to ionizing radiations, a requirement can be to withstand radiation values of between 200 and 300 Gy. The device can also be designed to comply with the ATEX regulations.

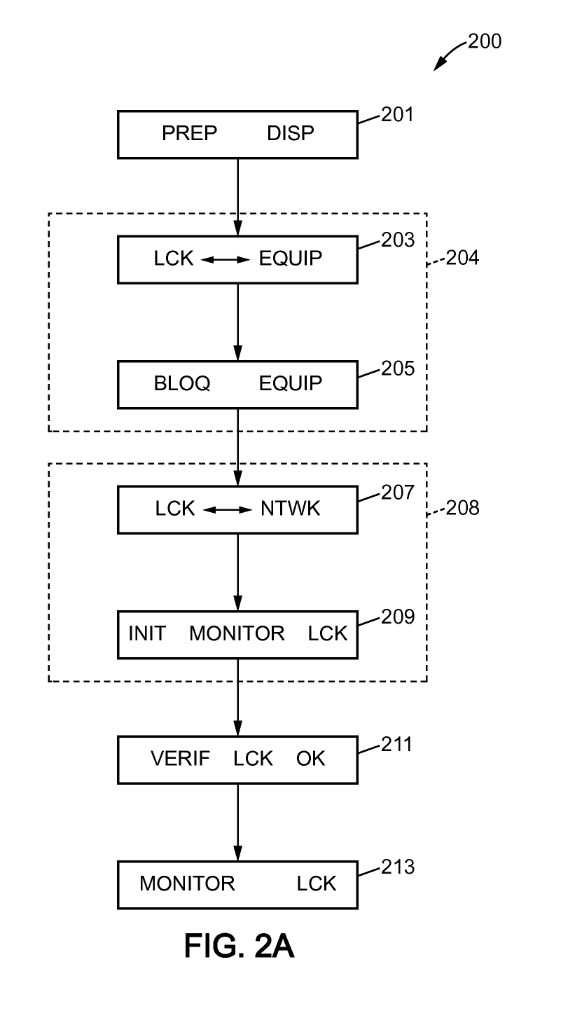

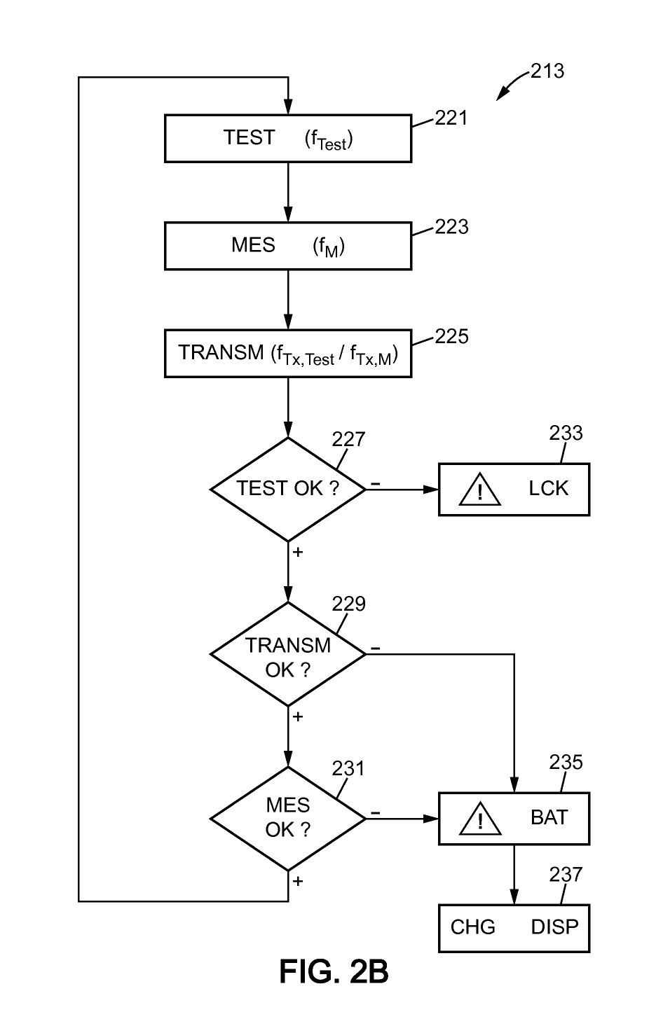

Reference will now be made to FIG. 2A, which shows the steps of a method 200 of supervision of the locking of an item of equipment by a communicating lockout device 100 such as described above.

The method 200 comprises a prior step of preparation 201 of the communicating lockout device during which the data item relating to the charge level of the local power supply module of the communicating device is checked.

In order to do this, before any intervention on site, the operator responsible for lockouts accesses a supervision application, on a supervision server, in order to prescribe the list of the lockouts to install or to remove by identifying them with a functional reference.

For each lockout to be installed, the operator specifies the required position of the item of equipment to be monitored, as well as the foreseen duration of the installation of the lockout. A default duration, for example 90 days, can be provided here. This information on the duration of installation of the lockout serves to verify that the local power supply module 120 of the communicating lockout device has sufficient autonomy for functioning over the necessary supervision time.

Thus, before leaving for the site of the items of equipment to be locked out, the operator checks that the prepared communicating devices 100 will be able to operate over the whole of the estimated duration. To do this, he accesses a module appended to the supervision application, without necessarily interrupting that supervision, which allows him to scan the communicating devices 100, retrieve their identifiers by means of their identification module 105, and to interrogate the database of the supervisor in order to know the latest charge level (i.e. residual energy) communicated by the communicating lockout device.

After the communicating lockout device has been scanned, two cases can arise:
Either the local power supply module of the communicating lockout device has a lifetime compatible with the predicted supervision time. In this case, the power supply means of the device are not changed. The charge level used is the last value transmitted by the communicating device 100 before its removal, weighted by the self-discharge coefficient of the power supply means. In order to indicate this situation, the first display unit 131 can then flash a certain number of times in a specific colour. For example, this indication can consist of flashing for 30 seconds in green using flashes corresponding to lighting for only 30% of a cycle (duty cycle=30%).
Or the local power supply module of the communicating lockout device does not have a lifetime compatible with the predicted supervision time. It is then necessary to change the power supply means 121 or recharge them. In this case, the installation of new power supply means 121 reinitializes the charge meter of the power supply module in the communicating lockout device. The supervision application will be updated the next time the communicating lockout device is started. In order to indicate this situation, the first display unit 131 can then flash a certain number of times in a specific colour different from the one mentioned above. For example, this indication can consist of flashing for 30 seconds in red using flashes again corresponding to lighting for only 30% of a cycle (duty cycle=30%).

In a first embodiment of this preliminary preparation step, the operator checks, device by device, that the operational lifetime is compatible and pre-records the equipment-device pair in a portable device, for example in a PDA, allowing him to go to the site of the items of equipment to be locked out.

In another embodiment of this preliminary preparation step, the operator briefly checks that the charge levels are sufficient and goes to the site of the items of equipment to be locked out with more communicating devices 100 than necessary, knowing that the charge level of these devices will finally be checked when they are installed.

The operator's portable device is loaded with the data of a round to be completed by the operator, together with the characteristics of all the locking devices of the site, in order to avoid invariably preparing equipment-locking device combinations before leaving for the site.

The fact of not changing the power supply means 121 of the communicating devices 100 before each installation can make it possible to economize these power supply means and avoid unnecessary operations. The lifetimes of the padlocks ready to be fitted are thus heterogeneous.

Once the operator is close to the equipment 1 to be locked out, provided with his prepared communicating lockout device, the association of the communicating lockout device with that equipment 1 is then carried out both virtually (step 203) and physically (step 205).

The virtual association 203 is a step during which the communicating lockout device and the equipment to be monitored are associated by computer. Such a step of virtual association 203 uses the equipment to be monitored, the communicating lockout device and the operator's portable device (PDA).

In order to make this virtual association, the operator's portable device is equipped with a reader capable of detecting the code of the identification module of the communicating device 100. When the latter and the equipment are marked by means of an RFID tag, the operator's portable device is capable of detecting both the code of the RFID tag of the equipment 1 to be monitored and the code of the RFID tag of the communicating device 100, in any order.

Preferably, the maximum time between these two readings, for a device-equipment pair, is one minute. This time can however be set up. When the code is detected, a bleep can sound. The operator's portable device can also display an icon with the type of equipment and/or of device detected.

If the maximum time between the two readings of the tags of the communicating lockout device and of the equipment is exceeded, then provision can be made for imposing a restart of the association process. In order to do this, the operator's portable device erases the first tag read so that the user can scan the two tags again. The operator can also voluntarily interrupt the association step in progress on his portable device.

Advantageously, the reading distance is limited to less than a certain predetermined distance, for example 5 cm, in order to prevent any random reading of the tag of a nearby item of equipment. In fact, the operator's bag of communicating devices 100 is a potential source of error during this reading operation.

When the operator's portable device scans the identifier of a communicating device 100, a first line is displayed on the screen of the portable device. This first line can comprise the icon of the padlock type, the functional reference of the padlock and the estimated residual lifetime (i.e. the autonomy) of the power supply module of the communicating device 100, for example in days.

When the operator's portable device scans the identifier of an item of equipment 1, a second line is displayed on the screen of the operator's portable device. This second line comprises the icon of the equipment type, the functional reference of the equipment and the required position, as well as the predicted duration of installation.

Once the two lines are displayed, the operator can associate them and send them in real time, for example via a wireless network, to the supervision system.

In an advantageous embodiment, a single communicating device 100 is associated with a single item of equipment 1 at a specific time. It is however possible to use several communicating devices 100 for a single item of equipment 1, if this proves to be necessary. It is possible to change a communicating device on site but, for safety reasons, it is preferable not to associate a communicating device 100 with an item of equipment 1 if it has not previously been registered in the supervision system.

With regard to the physical association step 205, this is a step during which the communicating device 100 and the equipment 1 to be monitored are joined together mechanically.

This physical association consists in:
positioning the item of equipment 1 to be locked out in the required position;
optionally accessing contextual assistance information on the operator's portable device; and
mechanically joining the item of equipment 1 with the communicating device 100 in order to keep the item of equipment 1 in a locked position.

If the locking means 101 of the communicating device 100 consist of a cable, the latter operation amounts to placing the cable around the item of equipment 1 and then tightening it such that operating the item of equipment is impossible. It can then be appropriate to mechanically lock the cable with a dedicated key. If the activation means 140 include a lock 147 as shown in FIG. 1, the operator does this by turning the key in this lock towards the “LCK” position.

Checking the position of the equipment is particularly important when installing the lockout. In fact, in the event of an installation error, the probability that the checker does not detect the error increases. Unfortunately, in the case of a wireless communicating device 100, it is not always possible of have an electrical signal available to indicate the exact position of the equipment.

In order to overcome this difficulty, the operator's portable device (PDA) can be adapted for presenting information making it possible to check that the required position of the equipment is complied with correctly, for example by giving it access to documents in the form of text, diagrams, images, voice or video. Such access to this information can be facilitated by reading the tag of the item of equipment 1.

The order of the two steps of virtual 203 and physical 205 association is not fixed and can be reversed, these two steps together forming an overall step 204 of association of the communicating device 100 with the equipment 1 to be locked out.

Once the communicating device 100 is correctly associated with the equipment 1 to be locked out, a step 207 of virtual integration of the communicating lockout device in a supervision network is carried out at the request of the operator.

This step is initiated by manual activation by the operator. For example, when the activation means 140 include a lock 147 such as shown in FIG. 1, this step 207 is initiated by the operator by turning the key in this lock towards the “NTWK” position. Once this manual activation has been carried out, the communication of the communicating device 100 with the supervision system, for example using a wireless network, is initialized. As long as the communicating device 100 is not integrated in the network, the second display unit 133 remains in a particular state (it flashes in green for example).

At this stage, the applicable items of information (monitored equipment, installed position, etc.) are not yet taken into account; only the communication function is activated. The items of information transmitted by the communicating device 100 are at least as follows:

Identity of the communicating lockout device;

Closing of the communicating lockout device (locking);

Open/Closed state of the communicating lockout device; and

Residual energy.

Two data frames can be transmitted by the transmission unit 111: an application message frame and a diagnostic frame.

Once the communicating lockout device is integrated in the network, the second display unit 133 goes into another particular state (for example, it stops flashing and lights up in green continuously for one minute) to inform the operator that the operation of integration with the network operation has taken place correctly.

It is preferable to fix a maximum integration time of the communicating lockout device in the network. This time can be fixed at 5 minutes for example. Beyond this time, the second display unit 133 goes into a new particular state (it flashes in red for 1 minute for example), then the communicating device 100 stops operating. In order to restart it, the activation means 140 can be used for stopping the electronics and then reactivating them. If these activation means 140 include a lock 147 as shown in FIG. 1, this restart can be carried out by the operator by turning the key in this lock towards the “LCK” position (possibly to the open position if he wishes to change the device 100), then by turning the key to the “NTWK” position again.

Once the communicating lockout device is correctly integrated in the supervision network (step 207), it is then possible to request its placing under supervision (step 209).

In order to request the placing under supervision of the communicating lockout device, the operator can indicate the position of the locked out equipment by using one of the push buttons 141 or 143.

Thus, in the case where the equipment 1 can assume only two positions, open or closed, if the equipment is locked out in the closed position, the operator then presses the first button 141 (“OK valve closed”) or, if the equipment is locked out in the open position, the operator presses the second button 143 (“OK valve open”).

When the operator uses one of these push buttons, the request to place under “supervision of applications” is then sent to the supervision application by means of the transmission unit 111.

The second display unit 133 can then indicate a state of waiting for validation (for example by flashing in green) until an item of information indicating the validation of the placing under supervision is sent back from the supervision network to the communicating device 100. A maximum time of waiting for the reception of such validation information can be fixed, of the order of two minutes for example.

The information transmitted by the communicating lockout device with the request to place under “supervision of applications” by the padlock can be as follows:

Identity of the communicating lockout device,

Closing of the communicating lockout device (locking),

Open/closed state of the communicating lockout device,

Residual energy.

The information validating the placing of applications under supervision that is returned to the communicating device 100 can be positive or negative. In case of success, the second display unit 133 can change to another state (for example by remaining continuously lit in green for one minute).

Preferably, a second pressing on one of the two push buttons 141, 143 (“OK valve closed” or “OK valve open”) is ignored. It can be advantageous, in order to change the declaration of the position of the equipment 1, to request the stopping of the electronics and then restarting the phase of integration in the network, in order to avoid any operational error.

In the case of failure during this step, that is to say if the delay in the return of the information validating the placing of applications under supervision is exceeded, or if a problem is detected (such as for example the declaration of a bad position with respect to the one which had been foreseen), then the second display unit 133 can indicate a failed state (for example by flashing in red for 1 minute). It is then possible to allow the restarting of a sequence for declaration of placing under supervision in the required position by pressing one of the two buttons of the communicating lockout device without any time-out being applied.

It is possible to provide a maximum waiting time between the integration of the communicating lockout device in the network and the request for application of supervision. Such a maximum waiting time is not however necessary, in order to allow the user to choose the order of the two steps of integration 207 and of requesting the placing under supervision 209. These two steps 207 and 209, in any order, therefore form an overall step 208 of activation of the supervision device.

Once the communicating lockout device is functioning and the supervision is activated, a step 211 of local verification can be provided in order to be able to re-interrogate this local device in order to check its connect operation. This is the case for example for double checking of installation operations, for checking rounds, or even periodic tests on these items of equipment.

The principle of using such a local checking step of verification can be implemented simply. The operator presses the third push button 145 dedicated to testing the communicating lockout device in situ. Pressing this test button 145 activates the processor of the communication module 110 of the communicating device 100, which transmits all of the information that it normally generates, both from the network point of view and from the application point of view, to the supervisor via the supervision network.

The start of transmission of these items of information can be indicated by the two display units 131 and 133 of the communicating lockout device, which flash in green for example. In case of success of the transmission, both from the network point of view and from the supervision point of view, the two display units 131 and 133 change to continuous green; in the case of failure, these display means change to flashing in red.

Once the communicating lockout device is functioning and its placing under supervision is activated, the supervisor waits for measurements originating from it during a supervision step 213.

FIG. 2B shows such a supervision step 213 in more detail.

During this step 213, two cycles co-exist: a cycle of testing the locking means, corresponding to the test step 221, and a cycle of measuring the charge level of the local power supply module 105 of the communicating device 100, corresponding to the measuring step 223.

The test cycle 221 consists in carrying out the periodic test of the locking means of the device at a certain test frequency f_{Test}. Thus, for example every minute, the processor 113 of the communicating device 100 becomes active and then carries out a test on the locking means 101 of the device (for example a test of continuity of the cable, where the variation of a continuity parameter of the cable is detected).

If the locking means 101 respond positively to this test (which guarantees them staying in the locked position and their integrity), the information can simply be stored in a first implementation, without any data item being transmitted to the supervision system. If, on the contrary, the result of the test is negative, which can indicate that the integrity of these locking means 101 is called into question, the transmission unit 111 can be activated in order to be able to transmit an item of lockout data indicative of the unlocking of the device in a first embodiment.

In another embodiment, an item of lockout data proportional to the variation of a parameter of the locking means will be systematically transmitted at a transmission frequency f_{Tx,Test}, preferably lower than the test frequency f_{Test}. The determination of the correct locking (or not) of the locking means of the device will then be carried out at the level of the supervision system.

The following information can be collected in each measuring cycle: date, time, state of the locking means, autonomy, diagnostic (state of the batteries), alarm (in the case of pressing the wrong button).

The measuring cycle 223 consists in periodically measuring the charge level of the local power supply 105 of the device 100, at a certain measuring frequency f_{M}, and in determining a charge data item indicative of charge level.

The transmission step 225 consists in transmitting to the supervisor data is informing on the state of the communicating device 100. This step can consist, on the one hand, in activating the transmission unit of the device 100 periodically, at a certain transmission frequency f_{Tx,M}, advantageously lower than measuring frequency f_{M}, in order to transmit the item of charge data determined according to the measurement of the charge level of the local power supply 105.

Thus, the communication function of the communicating lockout device is activated periodically, for example every 3 or 4 minutes, then starts the transmission of a measurement frame, able to contain information on the level of accumulation of current, the voltage of a battery cell used in the local power supply module, the internal temperature of the device 100, etc., to the supervision system.

The transmission step 225 can consist, on the other hand, in transmitting an item of lockout data determined according to the variation of a parameter of the locking means, in a test frame comprising information on the locking state of the device, the position of the locked equipment, a datestamping, the identity of the device 100 used, etc., at a transmission frequency f_{Tx,Test}, preferably lower than the test frequency f_{Test}.

This approach of having two separate cycles, with test and measuring frequencies higher than the respective transmission frequencies, makes it possible to economise the use of the batteries of the device insofar as the activation of the transmission unit 111 is a particularly heavy consumer of energy. The frequencies of these two cycles can be configurable by software, in order to allow different test scenarios.

In a control room or in the lockout office of the industrial installation in which the items of equipment are locked out, each of the lockouts is monitored by the supervisor. Any detected alarm is revealed.

The alarms have two possible origins: the transmission of a fault by a communicating lockout device or the non-reception of information from the communicating lockout device over a period greater than a certain number of transmission cycles.

Thus, during the three verification steps 227, 229 and 231, these two conditions are verified in order to determine if the communicating device 100 exhibits a risk of unlocking.

If, on the one hand, the transmitted data item indicative of the state of the locking means 101 of the device 100 indicates that the latter would be unlocked or that the integrity of these locking means would be called into question (first verification step 227), then a first alarm signal is generated and transmitted (step 233). This first alarm signal indicates the risk of an unlocking of the equipment 1 and exhibits a maximum degree of urgency necessitating an operator going on site in order to check the state of the item of equipment 1 and to re-lock it.

If, on the other hand, the supervisor observes that a certain number of consecutive cycles (two or even more depending on tests with the users) of transmission of the state of the communicating device 100 have not been received (second verification step 229), then a second alarm signal is also generated and transmitted (step 235). This second alarm signal indicates that the transmission unit 111 has not been able to transmit data, and exhibits a lower degree of urgency than the preceding one, nevertheless also necessitating an operator going on site in order to carry out diagnostics on the faulty communicating device 100.

Finally, if the transmitted data item indicative of the charge state of the local power supply module 120 indicates that it would be discharged is received (third verification step 231), then the second alarm signal is also generated and transmitted (step 235). This second alarm signal indicates that the communicating device 100 must be recharged, or replaced by a charged device, which exhibits a lower degree of urgency that the first alarm but which nevertheless also necessitates an operator going on site in order to deal with the faulty communicating device 100.

If these three verifications are validated, then the communicating device 100 is still in the locked position and is still communicating correctly with the supervision system and the supervision can continue.

The principles of presentation, selection, sorting, taking into account and inhibition of the alarms are similar to the standard alarm management mechanisms of commercial supervisors (SCADA).

It is preferable that any alarm confirmed in the management application initiates a new fitting of a communicating device 100 on site.

The supervision application manages a live signal, that is to say it is capable of warning the user of its operational state. If the supervision application is caused to stop and then to restart, this can cause the control team to refit all of the padlock locking devices. In order to avoid this, it is possible to allow the restarting of the supervision and the release of the alarms, even though several transmission cycles have failed.

When a communicating device 100 must be removed, for example when the charge state of its local power supply means becomes insufficient, a step 237 of removal is carried out.

As for the installation, the removal of the communicating device 100 is prepared in the lockout office, on the supervision utility. For each removal, the person responsible for lockouts, or the operational leader, gives information on the position of the equipment as well as the scheduled date of the intervention.

When the removal request is validated, the supervision system can indicate by a colour code and/or in a specific list, that the removal is programmed. In the supervision utility, an alarm can be programmed to warn that a lockout whose removal has been scheduled has not yet been removed.

When the removal request is validated, the operator can go and carry out a step of removal of the communicating device 100 of the lockout in question. The supervision is maintained for as long as the operator has not removed the communicating device 100.

Any request for removal of lockout is the subject of a request from the supervision interface. The removal request is indicated on the supervision interface by means of a specific colour or by a graphical identification. In the case of detection of a change of position of the equipment not initially foreseen, the supervision remains active and the mechanisms for taking into account and release remain valid and active.

On site, during the removal step 237, the unlocking of the locking means causes a request for the deactivation of the supervision. Preferably, the supervision is deactivated only if it was the subject of a request from the supervision interface and if the activation means of the device was operated for this purpose. If these two conditions are not jointly met, the supervision is maintained. If moreover the communicating lockout device has not been removed before the scheduled date, then an alarm is generated.

When the request for deactivation of the supervision is transmitted, the two display units 131 and 133 can change state, for example they can flash alternately in red. The electronics of the communicating device 100 send an end of putting into position message as well as an associated diagnostic message in order to communicate the latest charge level of the local power supply means. The communicating device 100 then stops by itself.

The supervision application records the removal items of information: functional reference of the equipment, functional reference of the communicating lockout device, position just before removal, date and time of removal. When the ending of supervision is confirmed by the supervisor, the two display means 131 and 133 can change state, for example by flashing alternately in green for one minute.

A log of the supervision application can be kept in order to retain the history of the lockout events. This log contains the list of the lockouts installed. This list can be sorted according to the following characteristics: time and date of fitting, presence or not of an alarm, level of the batteries, state of the lockout (being fitted, fitted, double check carried out, active, alarm taken into account, removal request carried out, removal carried out).

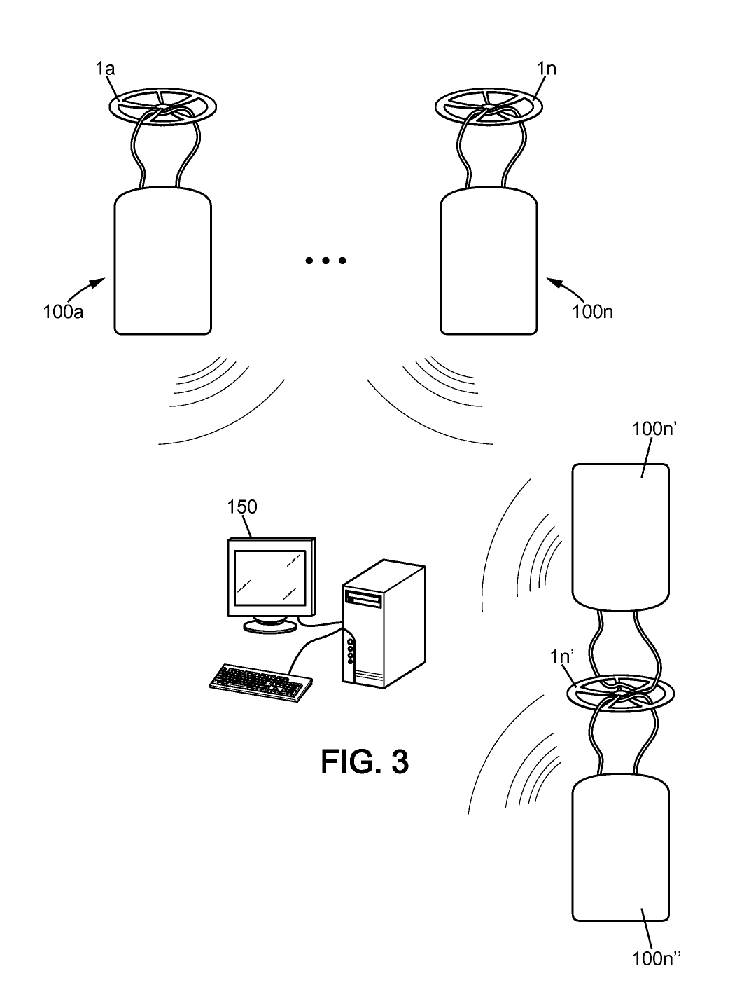

Reference will now be made to FIG. 3, which shows a system for the supervision of a plurality of items of equipment comprising a plurality of communicating lockout devices and a supervision server to communicate with each of said communicating lockout devices according to the present invention.

In this system, a supervision server 150 communicates with several communicating lockout devices 100a, . . . , 100n, 100n′ and 100n″ which are similar to the lockout device 100 described in FIG. 1.

As illustrated in this FIG. 3, each of the communicating lockout devices 100 a, . . . , 100n is used to maintain respectively a single item of equipment 1a, . . . , 1n in a fixed position.

On the other hand, two other communicating lockout devices 100n′ and 100n″ are used to maintain the item of equipment 1n′ in a fixed position, to illustrate the fact that any number of lockout devices can be used in association with a single item of equipment to be maintained in a fixed position.

Thus, in such a system, a global management of the plurality of communicating lockout devices 100a-100n″ can be performed centrally by the supervision server 150.

The invention is not of course limited to the embodiments described and shown above, on the basis of which other ways and forms of embodiment can be provided without thereby departing from the scope of the invention.

The present invention can advantageously be applied to the supervision of the lockout of many items of equipment to be positioned in a fixed position, in particular in large scale industrial installations comprising kilometres of ducting with a large number of valves to monitor, such as nuclear, thermal or gas power stations, the oil, chemical or iron and steel industries.

The use of a communicating lockout device according to the present invention can also be advantageous in the manufacturing industry (batch processing) in order to lock items of equipment in safe positions in order to limit any potential accident, for example in order to lock travelling cranes, assembly robots or engines among other things.

What is claimed is:

1. A communicating lockout device of an item of equipment comprising locking means able to maintain the equipment in a fixed position, a communication module able to communicate at least data relating to said locking means and a local power supply module adapted to supply electrically at least the communication module, wherein the local power supply module comprises a charge monitoring unit arranged for measuring the charge level of the local power supply module.

2. The communicating lockout device according to claim 1, wherein the communication module comprises a transmission unit connected to the charge monitoring unit and arranged for transmitting, to a remote supervision system, at least a charge data item determined according to the measured charge level.

3. The communicating lockout device according to claim 2, wherein the charge data item is proportional to the measured charge level.

4. The communicating lockout device according to claim 2, wherein said charge data item is measured at a predetermined measuring frequency and the transmission unit is activated periodically, at a first predetermined transmission frequency lower than this measuring frequency, in order to transmit said charge data item to the remote supervision system.

5. The communicating lockout device according to claim 1, wherein the communication module comprises at least a first display unit connected to the charge monitoring unit and arranged to produce at least a predetermined display depending on the measured charge level.

6. The communicating lockout device according to claim 1, further comprising a test module connected to the locking means and arranged for measuring the variation of at least one parameter of said locking means at a predetermined test frequency and the transmission unit is activated periodically, at a second predetermined transmission frequency, lower than the test frequency, in order to transmit to the remote supervision system an item of lockout data determined according to the measured variation.

7. The communicating lockout device according to claim 1, further comprising an electrically passive identification means.

8. A system for the supervision of a plurality of items of equipment comprising a plurality of communicating lockout devices and a supervision server arranged to communicate with each of said communicating lockout devices, wherein each of the communication lockout devices comprises locking means able to maintain an item of equipment in a fixed position, a communication module able to communicate at least data relating to said locking means and a local power supply module adapted to supply electrically at least the communication module, wherein the local power supply module comprises a charge monitoring unit arranged for measuring the charge level of the local power supply module.

9. A method of supervision of the locking of an item of equipment by a communicating lockout device powered by a local power supply module, the method comprising the association of said communicating lockout device communicating with the item of equipment placed in a fixed position, followed by the supervision of the communicating lockout device, wherein the supervision step comprises the measurement of the charge level of the local power supply.

10. The supervision method according to claim 9, wherein the supervision step comprises the transmission to a supervision system of at least one item of charge data determined according to at least one of the measured charge level and the activation of a display unit of the device according to the measured charge level.

11. The supervision method according to claim 9, in which the measurement of the charge level of the local power supply is carried out periodically at a predetermined measuring frequency, wherein the transmission step comprises the periodic activation of a transmission unit, at a first predetermined transmission frequency lower than said measuring frequency, in order to transmit said item of charge data to the remote supervision system.

12. The supervision method according to claim 9, in which the communicating lockout device comprises locking means capable of locking the item of equipment in a fixed position, wherein the supervision step comprises a test sub-step during which the variation of at least one parameter of said locking means is measured periodically at a predetermined test frequency, the transmission step comprising the periodic activation of a transmission unit, at a second predetermined transmission frequency lower than said test frequency, in order to transmit to the remote supervision system an item of lockout data determined according to the measured variation.

13. The supervision method according to claim 9, comprising the transmission of an alarm signal if no data is received from the communicating device by the supervision system over a period longer than a predetermined number of transmission cycles or depending on the item of charge and/or lockout data received.

14. The supervision method according to claim 9, in which the communicating lockout device comprises a first electrically passive identification means and the equipment has a second electrically passive identification means, wherein the association step comprises a sub-step of virtual association of the device and the item of equipment during which said identification means are read by a portable device and associated in a memory of said portable device.

15. The supervision method according to claim 9, comprising the prior preparation of the device comprising the verification of the last item of charge data transmitted to the supervision system by the communicating device.

16. The supervision method according to claim 9, comprising the activation of the communicating device following its association with the item of equipment and the verification of the communication between the communicating device and the remote supervision system.
